(19) United States
(12) Patent Application Publication
(10) Pub. No.: US 2009/0303886 A1
(43) Pub. Date: Dec. 10, 2009

(54) Method And System For Analyzing Gateways

(75) Inventors: Matthew Feczko, Newton, MA (US); Jisoo Lee, Princeton, NJ (US); Relenie Cormier, North Brunswick, NJ (US)

Correspondence Address: MORGAN, LEWIS & BOCKIUS LLP, 1701 MARKET STREET, PHILADELPHIA, PA, 19103-2921, US

(73) Assignee: LEHMAN BROTHERS INC., New York, NY (US)

(21) Appl. No.: 12/133,042

(22) Filed: Jun. 4, 2008

(51) Int. Cl. G06F 11/00

(52) U.S. Cl. 370/244

(57) ABSTRACT

An analysis is performed to test whether a gateway is functioning properly. The gateway includes a plurality of ports. Routing information for the gateway is received. A plurality of concurrent calls is generated for the ports of the gateway. The concurrent calls are pushed to the gateway in accordance with the routing information to determine whether the ports of the gateway are functioning properly.

### FIELD OF THE INVENTION

The disclosed embodiments relate generally to analyzing gateways, and more specifically, to analyzing gateways between voice networks.

### BACKGROUND

Gateways are nodes that act as an entrance and exit point between networks using different protocols to ensure interoperability between the networks. Gateways may be implemented using hardware or software, or both (e.g. software installed on a router or switch). In telecommunications, gateways are necessary mediums that connect calls from a local packet switched network, such as an internal voice-over-internet protocol (VoIP) network, to an outside circuit switched telephone network, such as the public switched telephone network (PSTN). One popular set of standards for the transmission of voice data within circuit switched telephone networks is the Integrated Services Digital Network (ISDN) standard, designed to transmit digital voice data over typically copper telephone wires. The ISDN standard uses a Basic Rate Interface (BRI) service in which voice data (i.e. calls) are carried over two Bearer (B) channels at 64 kilobits per second (kbit/s). The ISDN standard also uses a Primary Rate Interface (PRI) service commonly adopting either a T1 signaling scheme, in which voice data can be simultaneously carried over twenty-three 64 kbit/s B-channels, or an E1 signaling scheme, in which voice data can be simultaneously carried over 30 kbit/s D-channels. There exist other similar signaling schemes that regulate the transmission of multiple voice data, i.e. multiple calls, over networks of telephone wires. Accordingly, gateways connecting such networks can support multiple numbers of calls simultaneously.

To support multiple calls, a gateway has multiple ports corresponding to the multiple channels in which the calls are transmitted. A popular routing logic used to route calls through a gateway involves sending a call to the first available port. For example, if a gateway has 23 ports ordered from highest to lowest, and three calls needs to be routed to that gateway, the calls will be sent to ports 23, 22, and 21, consecutively. If a fourth call is made and the second call on port 22 has ended, the fourth call will be routed to port 22 rather than port 20. If all 23 ports on a gateway are unavailable, the next call will be routed to another gateway. Multiple gateways are commonly used to route calls from one network to another. For example, an office building may have 14 gateways, each having 23 ports, to support outbound calls from the building's internal VoIP network to the outside PSTN network. This allows for 322 concurrent calls to be made simultaneously.

If a particular port on a particular gateway fails to function properly, any calls routed to that port will immediately drop. As soon as the call is dropped, however, the port will become available again. Thus, if all other ports before the malfunctioning port are unavailable, calls will continue to be routed to this port. These issues will then be experienced by the user in the form of a busy signal. When a caller experiences repeatedly dropped calls due to this broken port, he may need to submit a ticket to a local help desk, which then routes the problem to a higher performance management group. To begin uncovering the problem, a technician will need to know the source number, destination number, and time of call so that a trace log can be reviewed to determine which gateway the call was routed. Once that gateway is located, it will need to be taken off the network to be placed onto a separate route list so that the technician can make multiple calls to reproduce the problem. Because it is not easy to realize that the call degradation is due to a particular malfunctioning port, this process may take many hours and even multiple technicians to solve. Moreover, not only does this process prove cumbersome and time consuming, in most cases the damage will already been done because such a process is merely reactive. Thus, there is a need for both an efficient and proactive way to test for malfunctioning gateways.

### SUMMARY OF THE INVENTION

The present invention is directed to a method, system and computer-readable medium for analyzing whether ports of a gateway are functioning properly. The gateway includes a plurality of ports. Routing information for the gateway is received. A plurality of concurrent calls is generated for the ports of the gateway. The concurrent calls are pushed to the gateway in accordance with the routing information to determine whether the ports of the gateway are functioning properly.

### BRIEF DESCRIPTION OF THE DRAWINGS

FIG. 1 is a diagram illustrating an exemplary system for analyzing gateways in accordance with some embodiments of the present invention.

FIG. 2 is an exemplary schematic screenshot of a route pattern configuration tool in accordance with some embodiments of the present invention.

FIG. 3 is a flow diagram of an exemplary process for pushing multiple concurrent calls to a specific gateway in accordance with some embodiments of the present invention.

### DETAILED DESCRIPTION

The disclosed embodiments provide a way to test the functionality of each of the multiple gateways connecting calls between networks by pushing multiple calls concurrently through each gateway and determining the outcome of each call. The disclosed embodiments also provide a way to analyze the outcome statistics tested for each gateway to determine the specific ports that are not functioning properly. In some embodiments, if a malfunctioning port or gateway is found, an alarm will immediately dispatch to networks operations via e-mail or some other medium. Malfunctioning ports and gateways can be determined within a matter of seconds and human interaction is not required.

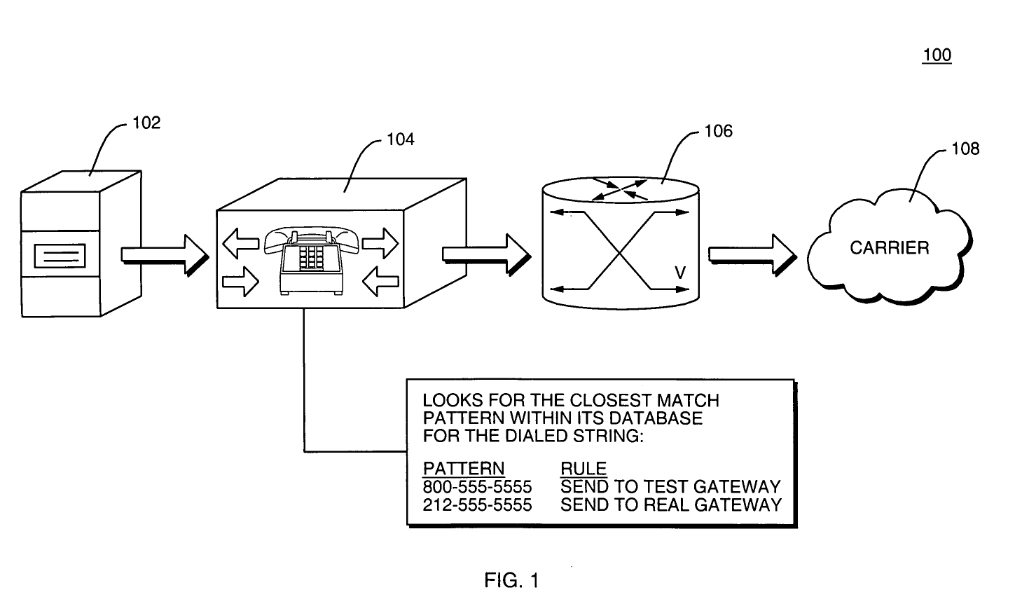

FIG. 1 is a diagram illustrating an exemplary system 100 for analyzing gateways in accordance with some embodiments of the present invention. System 100 may be implemented to test gateways for an ISDN PRI T1 system. In some other embodiments, however, system 100 may be implemented to test gateways for other types of voice networks that can support simultaneous calls. A PRI T1 system uses four wires, including two wires for sending digital data and two wires for receiving digital data. A PRI T1 system also consists of twenty-four 64 kbits/s channels, including twenty-three B-channels for carrying voice communication data and one channel carrying control and signaling information.

A PRI T1 system can be obtained by a customer from a telephone service provider known as a carrier. The carrier hands off the T1 system to the customer, who then connects it to a private branch exchange (PBX) system. The PBX system controls the routing of calls within the customer's private network. The system follows a set of rules that allow the customer to route each call to a desired gateway. In some embodiments, these gateways may serve as connections between networks within the customer's private network. In some embodiments, these gateways connect the customer's private network to the carrier's network. For example, in some embodiments, the T1 system is connected to the PBX system through a gateway. When a call is presented to the PBX system, the system compares the digits of the call to a list of route patterns within its database. A route pattern denotes the number used for an initiated call. Once the PBX system finds the closest matching route pattern, it will follow rules associated with that match to route the call to the designated gateway.

In some embodiments, the PBX system uses a call processing agent 104 to perform the pattern comparison and routing. The call processing agent 104 may be implemented by software, hardware, or both, and may contain a database that contains patterns and rules, such as the following, by way of example:

| Pattern | Rule |
|---|---|
| 800-555-5555 | Send to test gateway |
| 212-555-5555 | Send to real gateway |

When the call string is initiated from an application server 102, the call processing agent 104 will look within its database for the closest matching pattern to the dialed string. If the call string matches the pattern 800-555-555, the call processing agent 104 will consult the rule associated with that pattern to send the call to a test gateway. If the call string matches the pattern 212-555-555, the call processing agent 104 will consult the rule associated with that pattern to send the call to a gateway 106, which in turn sends the call to a carrier 108.

Route patterns can also be used to route a call to multiple gateways. In some embodiments, the PBX system database contains route patterns that are defined into route lists, which are further defined into route groups associated with multiple gateways. These route lists and groups can be configured by a route pattern configuration tool that allows the customer to add, delete or reorder, for example, any route groups within a route list. Such a configuration tool provides the customer with flexibility in creating rules to govern how calls should be routed within the customer's private network and allows for differentiation between the various needs of the customer. In some embodiments, a specific route pattern is created within call processing agent 104 to be used by the overall gateway testing analysis. This specific route pattern is configured to forward a call to a specific route list containing a specific route group associated with a gateway.

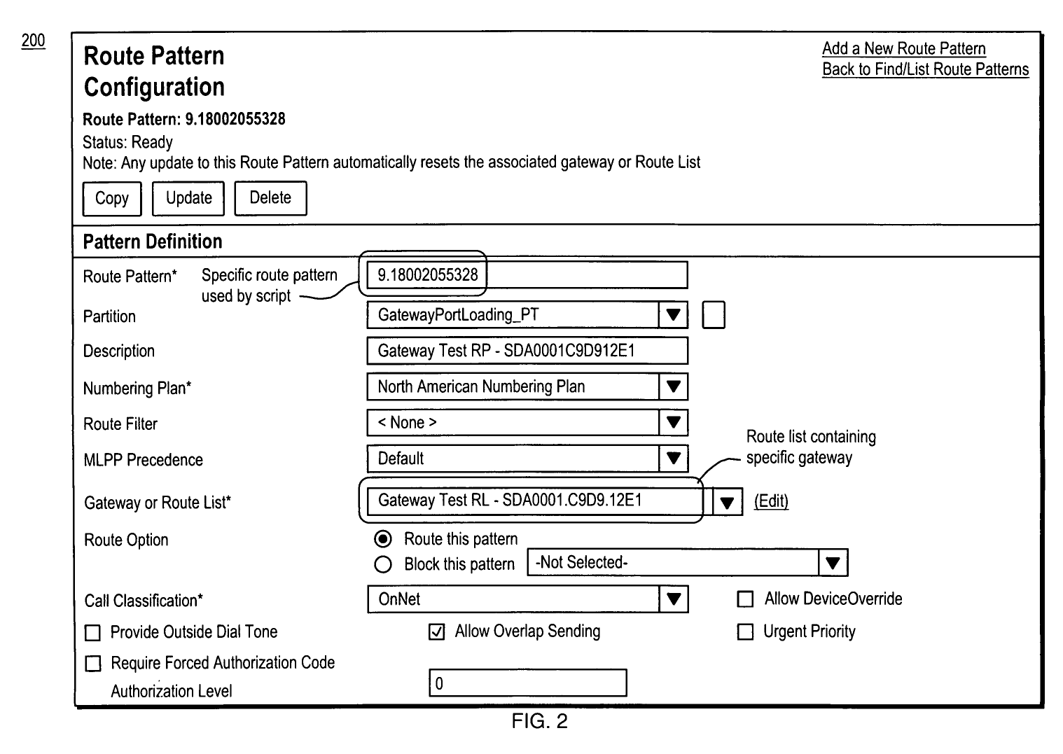

FIG. 2 is a schematic screenshot of a route pattern configuration tool 200 in accordance with some embodiments. The route pattern configuration tool 200 displays entry fields in which a customer can select route lists containing specific gateways under a specific route pattern. Once a route pattern, route list and route group have been configured within call processing agent 104, system 100 can send multiple calls to designated gateways according to these configurations.

System 100 uses application server 102 to send multiple concurrent calls between the networks. In some embodiments, if system 100 is implemented to test gateways for an ISDN PRI T1 system, application server 102 will send 23 concurrent calls associated with the 23 B-channels and ports connecting to each gateway. In some embodiments, the application server 102 is a gateway using a H.323 system specification and allows calls to be transmitted through the gateway. Such a gateway contains registration information on all calls sent through the gateway and controls the registration information to the application server 102 itself.

The actual calls sent by application server 102 are initiated by a call-making application running on application server 102. Such a call-making application also has access to a media server or run a media server locally to handle resource and memory allocation associated with the various communication links. In some embodiments, the call-making application uses the application server as an origination point akin to a telephone, and the media server as a resource to initiate calls to external locations. The application server 102 and the media server may run on one machine or separate machines, which allows for a higher number of concurrent calls to be made. In some embodiments, the call-making application can be accessed on application server 102 via a URL address so that making an external call can be simply performed by opening a, web browser and pointing to a specific address. In some embodiments, after a HTTP request is made, a call is initiated to a number passed in via query parameter, and the call-making application will then wait for a response or hang up within, e.g., 5 seconds. A successful call will return a string representing success, such as the specific string number of a call ID, whereas a failed call will return a string representing failure. This call-making application is, in turn, used by system 100 to generate multiple concurrent calls to a designated gateway in order to test the functionality of that gateway.

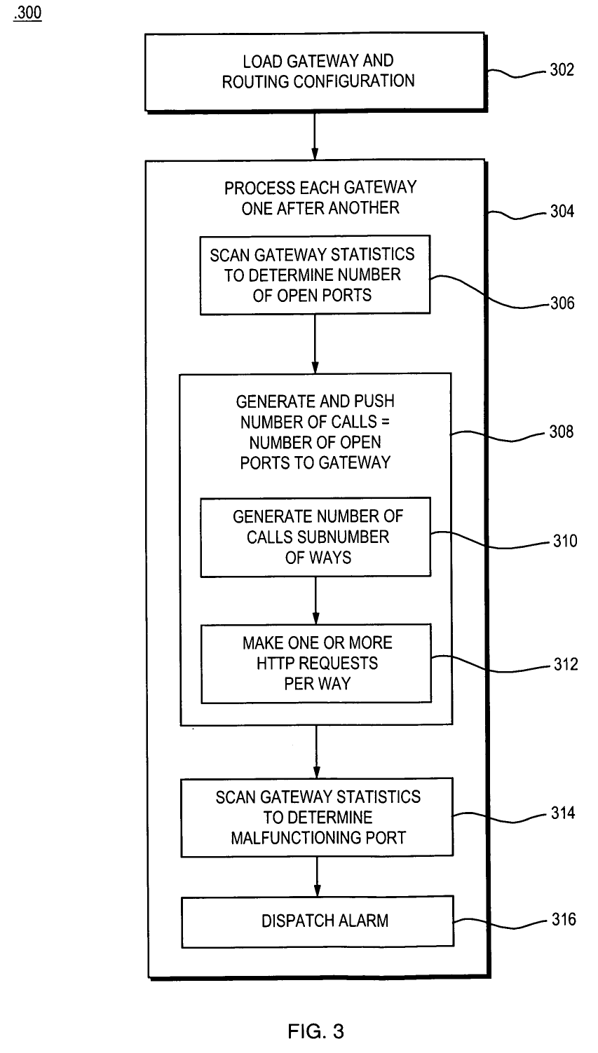

FIG. 3 is a flow diagram of a process 300 for generating and pushing multiple concurrent calls to a specific gateway in accordance with some embodiments. Process 300 may be implemented by a set of instructions running on a server. In some embodiments, process 300 initially loads configuration data for the gateways being tested from an external XML file containing all gateways and numbers routed through them (step 302). Process 300 then processes each gateway to determine the functionality of that gateway (step 304). In some embodiments, process 300 tests each gateway one after another, rather than simultaneously, so that gateways not being tested can be available to callers. In some embodiments, before testing each gateway, process 300 will scan the gateway's statistics to determine the number of ports currently open on that gateway (step 306). Process 300 will then push that number of concurrent calls to the gateway (step 308). For example, in an ISDN PRI T1 system in which 23 simultaneous calls can be sent through one gateway and if three callers are currently sending calls through a gateway, process 300 will only push 20 calls to that gateway.

In order to push a multiple number of calls simultaneously to a gateway, process 300 combines forking, in which multi-threaded processes are created from a parent process, with a parallel request, in which multiple call initiation requests can be made concurrently. This methodology creates a sub-number of processes that is less than the number of concurrent calls and initiates one or more of the number of concurrent calls for each of the sub-number of processes (steps 310, 312). Such a method is more efficient than using forking alone to divide the process into as many threads as there are calls to be pushed or using parallel requests only to initiate the requisite number of calls. For example, in an ISDN PRI T1 system in which 23 simultaneous calls can be sent through one gateway, process 300 may generate calls in four parallel ways and make five or six parallel HTTP requests to the call-making application running on application server 102.

Thus, process 300 can fully test all ports of the gateway in a matter of seconds. Those gateways that are functioning properly will receive all requisite number of calls and hang up within half a second, and those gateways that have broken ports will immediately drop certain calls, with 0 bytes of data through the broken ports. After all calls are complete, process 300 will scan the gateway's statistics to determine which ports have 0 bytes of data and are therefore broken (step 314). In some embodiments, if any of the calls are dropped for a gateway or any of the ports of that gateway are potentially broken, process 300 may dispatch an alarm to networks operations in the form of an e-mail or some other medium (step 316). Process 300 will then continue analyzing the next gateway indicated by the configuration data.

The foregoing description, for purposes of explanation, has been described with references to specific embodiments. The illustrative discussions above, however, are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular user contemplated.

What is claimed is:

1. A method of analyzing one or more gateways wherein one or more of the gateways each comprise one or more ports, the method comprising, for each of one or more of the gateways:
receiving routing information for a gateway;
generating for the gateway a plurality of concurrent calls associated with a plurality of ports; and
pushing the plurality of concurrent calls to the gateway in accordance with the routing information for the gateway to determine whether one or more of the plurality of ports are functioning properly.

2. The method of claim 1, wherein the plurality of concurrent calls are generated in a subnumber of ways that is less than a number of the plurality of concurrent calls.

3. The method of claim 1, wherein the pushing comprises:
receiving one or more requests wherein a successful call for a gateway returns data representing success and a failed call for a gateway returns data representing failure.

4. The method of claim 1, further comprising:
originating the plurality of concurrent calls via an application server; and
initiating the plurality of concurrent calls via a media server.

5. The method of claim 4, wherein the application server and the media server run on separate machines.

6. The method of claim 3, wherein the pushing further comprises scanning the data representing success and the data representing failure for one of more ports associated with failed calls.

7. The method of claim 6, further comprising dispatching an alarm if any of the ports are associated with failed calls.

8. A system comprising:
one or more gateways, wherein one or more of the gateways each comprise one or more ports;
one or more servers for generating for at least one of the gateways a plurality of concurrent calls associated with a plurality of ports; and
a calling application for pushing the plurality of concurrent calls to the at least one gateway in accordance with routing information received for the at least one gateway to determine whether one or more of the plurality of ports are functioning properly.

9. The system of claim 8, wherein the plurality of concurrent calls are generated in a subnumber of ways that is less than a number of the plurality of concurrent calls.

10. The system of claim 8, wherein one or more requests are received by the calling application and wherein a successful call for a gateway returns data representing success and a failed call for a gateways returns data representing failure.

11. The system of claim 8 wherein the one or more servers comprise:
an application server for originating calls; and
a media server for initiating calls.

12. The system of claim 11, wherein the application server and the media server run on separate machines.

13. The system of claim 10, wherein the calling application is further for scanning the data representing success and the data representing failure for one or more ports associated with failed calls.

14. The system of claim 13, wherein an alarm is dispatched if any of the ports are associated with failed calls.

15. A computer readable medium comprising instructions which, when executed by a processor, cause the processor to perform a method of analyzing one or more gateways wherein one or more of the gateways each comprise one or more ports, the method comprising, for each of one or more of the gateways:
receiving routing information for a gateway;
generating for the gateway a plurality of concurrent calls associated with a plurality of ports, and
pushing the plurality of concurrent calls to the gateway in accordance with the routing information for the gateway to determine whether one or more of the plurality of ports are functioning properly.

16. The computer-readable medium of claim 15, wherein the plurality of concurrent calls are generated in a subnumber of ways that is less than a number of the plurality of concurrent calls.

17. The computer-readable medium or claim 15, wherein the pushing comprises:
receiving one or more requests wherein a successful call for a gateway returns data representing success and a failed call for a gateway returns data representing failure.

18. The computer-readable medium of claim 15, wherein the method further comprises:
originating the plurality of concurrent calls via an application server; and
initiating the plurality of concurrent calls via a media server.

19. The computer-readable medium of claim 18, wherein the application server and the media server run on separate machines.

20. The computer-readable medium of claim 17, wherein the pushing further comprises scanning the data representing success and the data representing failure for one or more ports associated with failed calls.

21. The computer-readable medium of claim 20, wherein the method further comprises dispatching an alarm if any of the ports are associated with failed calls.
